(19) United States
(12) Patent Application Publication
(10) Pub. No.: US 2026/0055001 A1
(43) Pub. Date: Feb. 26, 2026

(54) METHOD FOR PRODUCING POTASSIUM SULFATE BY METATHESIS PROCESS, POTASSIUM SULFATE PRODUCT AND POTASH FERTILIZER

(71) Applicant: MiGao Century Engineering Technology (Chengdu) Limited Company, Chengdu City (CN)

(72) Inventors: Pingfu Sun, Chengdu City (CN); Guocai Liu, Chengdu City (CN)

(21) Appl. No.: 19/281,053

(22) Filed: Jul. 25, 2025

(30) Foreign Application Priority Data
Aug. 23, 2024 (CN) 202411168750X

(51) Int. Cl. C01D 5/08; C01D 5/16; C05C 11/00; C05G 5/10

(52) U.S. Cl. CPC C01D 5/08; C01D 5/16; C05C 11/00; C05G 5/10

(57) ABSTRACT

The present disclosure discloses a method for producing potassium sulfate by a metathesis process, a potassium sulfate product and a potash fertilizer, and relates to the field of potassium sulfate preparation methods. A solid ammonium sulfate and a solid potassium chloride are used as raw materials and are added in two steps for reaction, a first-stage reaction and a second-stage reaction are respectively carried out, then a third-stage reaction with hot water is carried out, and crystallization and separation are carried out, such that impurities in the product are fully removed, and meanwhile, the content of K₂O in the product is increased. The potassium sulfate product with high K₂O content and low chlorine content can be prepared through the three-stage reaction process provided by the present disclosure, and the method is simple and easy to implement and convenient for industrial application.

### CROSS-REFERENCE TO RELATED APPLICATIONS

The present disclosure claims the priority to the Chinese Patent Application No. 202411168750.X filed with the Chinese Patent Office on Aug. 23, 2024, and entitled “METHOD FOR PRODUCING POTASSIUM SULFATE BY METATHESIS PROCESS, POTASSIUM SULFATE PRODUCT AND POTASH FERTILIZER”, the contents of which are incorporated herein by reference in entirety.

### TECHNICAL FIELD

The present disclosure relates to the field of potassium sulfate preparation methods, in particular to a method for producing potassium sulfate by a metathesis process, a potassium sulfate product and a potash fertilizer.

### BACKGROUND ART

Potassium sulfate is an important chlorine-free potash fertilizer suitable for cash crops such as tobacco, citrus, tea, grapes, sugar beets, and sugarcane; the potassium it contains is one of the three major plant nutrients, and potassium is a macronutrient essential for plants, particularly beneficial for chlorine-sensitive crops, thus making the potassium sulfate a multi-nutrient fertilizer with broad applications. Additionally, potassium sulfate is a fundamental chemical raw material widely used in industries such as pharmaceuticals, glass, and dyes. As a result, the demand for potassium sulfate is very high, often leading to a situation where industrial production capacity falls far short of demand. Further research on potassium sulfate production processes holds significant practical importance.

Currently, the main methods for producing potassium sulfate include the method of comprehensive utilization of potassium ores, the method of comprehensive utilization of bittern, the Mannheim method, and various conversion methods using sulfates and potassium chloride as raw materials. Among them, the application of the comprehensive utilization of potassium ore and bittern is limited due to the influence of resources. The most commonly used method for industrial production of potassium sulfate is the Mannheim process, that is, potassium chloride reacts with sulfuric acid at high temperature. The raw materials are fed into a reaction furnace heated above 500° C.-600° C., and potassium sulfate and hydrochloric acid are produced by two-step reaction of potassium bisulfate. This method for producing potassium sulfate accounts for 40% to 50% of the global supply. However, the Mannheim process has drawbacks such as high investment costs, significant energy consumption, severe equipment corrosion, and poor marketability of byproduct hydrochloric acid, which also limit its development. Moreover, in the Mannheim process, in order to neutralize the acid in the intermediate product, limestone powder (the main component is calcium carbonate) is added, resulting in trace amounts of calcium sulfate in the final potassium sulfate product, and making the product not fully water-soluble, thus preventing its use as a fully water-soluble fertilizer.

In the method of using ammonium sulfate and potassium chloride as raw materials to produce potassium sulfate, since the price of potassium sulfate is much higher than that of potassium chloride, the byproduct potassium-containing ammonium chloride can be used as raw material of compound fertilizer or applied directly, thus making the method with good economic and social benefits, so it has gained increasing attention.

However, at present, the main problems in the process of preparing potassium sulfate from ammonium sulfate and potassium chloride are: the K₂O content in the potassium sulfate product is not sufficiently high, while the chloride ion content in the potassium sulfate product is relatively high, thus limiting its further application. In addition, the existing process of preparing potassium sulfate from ammonium sulfate and potassium chloride still suffers from some problems, such as complex process flow, high water consumption and difficult industrial application.

In view of this, the present disclosure is proposed.

### SUMMARY

The objectives of the present disclosure are to provide a method for producing potassium sulfate by a metathesis process, a potassium sulfate product and a potash fertilizer, and to provide a preparation process for the potassium sulfate product with high K₂O content and low chloride ion content.

The present disclosure is realized as follows.

In the first aspect, a method for producing potassium sulfate by metathesis process is provided in the present disclosure, including:
taking solid ammonium sulfate and solid potassium chloride as raw materials, carrying out a first-stage reaction in a solution system, and then crystallizing and separating, so as to obtain a primary crude potassium sulfate;
taking primary crude potassium sulfate, solid ammonium sulfate and solid potassium chloride as raw materials, carrying out a second-stage reaction in a solution system, and then crystallizing and separating, so as to obtain a secondary crude potassium sulfate, and
mixing the secondary crude potassium sulfate with hot water at 80° C.-98° C., carrying out a third-stage reaction, and then crystallizing and separating.

In an optional embodiment, the molar ratio of solid ammonium sulfate to solid potassium chloride for the first-stage reaction is 1:(1.4-2.2), and the molar ratio of solid ammonium sulfate to solid potassium chloride for the second-stage reaction is 1:(1.8-2.8).

In an optional embodiment, the process of obtaining the primary crude potassium sulfate includes: mixing and dissolving the solid ammonium sulfate, the mother liquor of secondary crude potassium sulfate and water to obtain an ammonium sulfate solution, mixing the ammonium sulfate solution and a solid potassium chloride for a first-stage reaction, and then cooling to crystallization and separating, so as to obtain a primary crude potassium sulfate and a mother liquor of primary crude potassium sulfate. Here, the mother liquor of secondary crude potassium sulfate is obtained by the process of separating and obtaining the secondary crude potassium sulfate.

In an optional embodiment, the mass ratio of solid ammonium sulfate, mother liquor of secondary crude potassium sulfate and water is 1:(2.0-3.2):(0.2-1.0).

Preferably, the temperature of the first-stage reaction is controlled at 60° C.-90° C. and the reaction duration is controlled at 1 h-3 h.

Preferably, the crystallization temperature after the first-stage reaction is controlled at 30° C.-60° C. and the crystallization duration is controlled at 1 h-3 h.

Preferably, when preparing the ammonium sulfate solution, the dissolution temperature is 60° C.-90° C.

In an optional embodiment, the mother liquor of primary crude potassium sulfate is used to prepare NK fertilizer byproducts.

Preferably, the mother liquor of primary crude potassium sulfate is evaporated and concentrated to obtain the concentrated NK fertilizer mother liquor, the concentrated NK fertilizer mother liquor is crystallized and separated to obtain the wet NK fertilizer product and the NK fertilizer mother liquor, and the wet NK fertilizer product is dried to obtain the NK fertilizer product.

More preferably, the NK fertilizer mother liquor is returned to the evaporation and concentration stage for recycling.

In an optional embodiment, the process of obtaining a secondary crude potassium sulfate includes: mixing and dissolving solid ammonium sulfate, primary crude potassium sulfate and mother liquor of potassium sulfate product to obtain a crystal slurry mixed solution; mixing the crystal slurry mixed solution with solid potassium chloride for a second-stage reaction, and then cooling to crystallization and separating, so as to obtain the secondary crude potassium sulfate and mother liquor of secondary crude potassium sulfate, and using the mother liquor of secondary crude potassium sulfate to dissolve the solid ammonium sulfate in the first-stage reaction. Here, the mother liquor of potassium sulfate product is obtained by crystallization and separation after the third-stage reaction.

In an optional embodiment, the mass ratio of solid ammonium sulfate, primary crude potassium sulfate and mother liquor of potassium sulfate product is 1:(2.2-3.3):(4.8-6.2).

Preferably, the temperature of the second-stage reaction is controlled at 60° C.-90° C. and the reaction duration is controlled at 1 h-3 h.

Preferably, the crystallization temperature after the second-stage reaction is controlled at 30° C.-60° C. and the crystallization duration is controlled at 1 h-3 h.

Preferably, when preparing the crystal slurry mixed solution, the dissolution temperature is 60° C.-90° C.

In an optional embodiment, the reaction temperature of the third-stage reaction is controlled at 60° C.-90° C. and the reaction duration is controlled at 0.5 h-2.0 h.

Preferably, the mass ratio of secondary crude potassium sulfate to hot water is controlled at 1:(0.8-1.2).

Preferably, after the third-stage reaction, crystallization is conducted at 30° C.-60° C. for 1 h-3 h, followed by separation to obtain the wet potassium sulfate product and the mother liquor of potassium sulfate product, and the wet potassium sulfate product is dried to obtain the potassium sulfate product.

More preferably, the mother liquor of potassium sulfate product is used to dissolve the solid ammonium sulfate in the second-stage reaction.

In the second aspect, a potassium sulfate product is provided in the present disclosure, wherein the potassium sulfate product is prepared by the method of any one of the aforementioned embodiments.

Preferably, the K₂O content of the potassium sulfate product is 50.0 wt %-51.5 wt %, the chloride ion content is less than 0.3 wt %, the moisture content is less than 0.5 wt %, and the content of water insoluble matter is less than 0.05 wt %.

In the third aspect, a potash fertilizer is provided in the present disclosure, wherein the potash fertilizer includes the potassium sulfate product in the aforementioned embodiments.

The present disclosure has the following beneficial effects: according to the present disclosure, a solid ammonium sulfate and a solid potassium chloride are used as raw materials and are added in two steps for reaction, a first-stage reaction and a second-stage reaction are respectively carried out, then a third-stage reaction with hot water is carried out, and crystallization and separation are carried out, such that impurities in the product are fully removed, and meanwhile, the content of K₂O in the product is increased. The potassium sulfate product with high K₂O content and low chlorine content can be prepared through the three-stage reaction process provided by the present disclosure, and the method is simple and easy to implement and convenient for industrial application.

### BRIEF DESCRIPTION OF THE DRAWINGS

In order to more clearly illustrate the technical solutions of examples in the present disclosure, the drawing to be used in examples will be briefly introduced below. It should be understood that the following drawing only shows some examples of the present disclosure, so they should not be regarded as limiting the scope, for a person of ordinary skill in the art, other drawings can be obtained according to the drawing without inventive efforts.

FIG. 1 shows a process flow chart for preparing potassium sulfate by the method of liquid phase metathesis provided by the example of the present disclosure.

### DETAILED DESCRIPTION OF EMBODIMENTS

In order to make the purpose, technical solutions and advantages of the examples of the present disclosure clearer, the technical solutions in the examples of the present disclosure will be described clearly and completely below. Where specific conditions are not specified in the examples, it shall be carried out according to the conventional conditions or the conditions suggested by the manufacturer. The reagents or instruments used without indicating the manufacturer are conventional products that can be obtained through commercially available purchase.

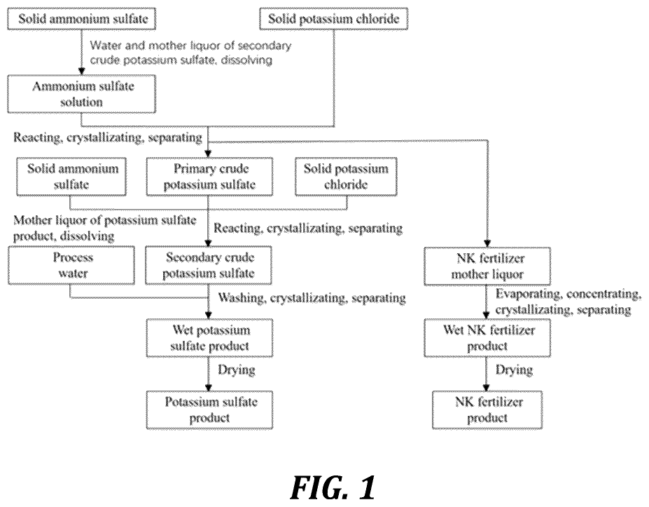

A method for producing potassium sulfate by metathesis process is provided in the example of the present disclosure, referring to FIG. 1, which includes the following steps.

### S1, First-Stage Reaction

The solid ammonium sulfate and solid potassium chloride are used as raw materials, after the raw materials are dissolved, a first-stage reaction is carried out in a solution system, and then cooling to crystallization and separating, so as to obtain a primary crude potassium sulfate and a mother liquor of primary crude potassium sulfate, wherein the primary crude potassium sulfate is used for the second-stage reaction in step S2, and the mother liquor of primary crude potassium sulfate is used for preparing NK fertilizer in step S4.

In some examples, the steps of the first-stage reaction include: mixing and dissolving the solid ammonium sulfate, the mother liquor of secondary crude potassium sulfate and water to obtain the ammonium sulfate solution, mixing the ammonium sulfate solution and the solid potassium chloride to perform the first-stage reaction, fully reacting at high temperature, then cooling to crystallization, and separating, so as to obtain the primary crude potassium sulfate and the mother liquor of primary crude potassium sulfate. Here, the mother liquor of secondary crude potassium sulfate is obtained by the process of separating and obtaining the secondary crude potassium sulfate (that is, the mother liquor of secondary crude potassium sulfate). As the mother liquor of secondary crude potassium sulfate contains a relatively high content of ammonium chloride, the mother liquor of secondary crude potassium sulfate is recycled back to the first-stage reaction, and as the mother liquor of primary crude potassium sulfate obtained after the reaction is used to prepare NK fertilizer in step S4, the N in raw materials can be fully utilized.

In some examples, the molar ratio of solid ammonium sulfate to solid potassium chloride used in the first-stage reaction is 1:(1.4-2.2), for example, 1:1.4, 1:1.5, 1:1.6, 1:1.7, 1:1.8, 1:1.9, 1:2.0, 1:2.1 and 1:2.2, etc. The molar ratio of solid ammonium sulfate to solid potassium chloride is preferably within the above range, so as to ensure complete reaction of the raw materials and improve product yield. The mass ratio of solid ammonium sulfate, mother liquor of secondary crude potassium sulfate and water is 1:(2.0-3.2):(0.2-1.0), for example, it can be 1:2.0:0.2, 1:2.5:0.5, 1:3.0:0.8, 1:3.2:1.0, etc. By adjusting the amounts of mother liquor of secondary crude potassium sulfate and water, the solid ammonium sulfate is fully dissolved, and the solid content of the solution is maintained at an appropriate level, so as to facilitate the reaction with potassium chloride.

In some examples, when preparing ammonium sulfate solution, the dissolution temperature is 60° C.-90° C., so as to make solid ammonium sulfate dissolve quickly, and this process can be carried out in a dissolution tank with a heating device, so as to provide the heat required for dissolution. Specifically, the dissolution temperature can be 60° C., 65° C., 70° C., 75° C., 80° C., 85° C., 90° C., etc.

In some examples, the prepared ammonium sulfate solution and solid potassium chloride are added into the reactor at the same time, and stirred for reaction. The temperature of the first-stage reaction is controlled at 60° C.-90° C. and the reaction duration is controlled at 1 h-3 h, so that the ammonium sulfate and potassium chloride can fully react and the utilization rate of raw materials can be improved. Specifically, the first-stage reaction can be carried out in a reactor with a heating device to maintain the reaction temperature to meet the requirements. The temperature of the first-stage reaction can be controlled at 60° C., 65° C., 70° C., 75° C., 80° C., 85° C., 90° C., etc., and the reaction duration can be controlled at 1.0 h, 1.5 h, 2.0 h, 2.5 h, 3.0 h, etc.

Furthermore, after the high-temperature reaction, the solution in the reactor is transferred into a crystallizer, cooled and crystallized, wherein the crystallization temperature is controlled at 30° C.-60° C. and the crystallization duration is controlled at 1 h-3 h, so that the potassium sulfate can be fully precipitated. Specifically, the crystallization temperature can be controlled at 30° C., 35° C., 40° C., 45° C., 50° C., 55° C., 60° C., etc., and the crystallization duration can be controlled at 1.0 h, 1.5 h, 2.0 h, 2.5 h, 3.0 h, etc.

Furthermore, the system, after cooling to crystallization, is subjected to solid-liquid separation, wherein the way of solid-liquid separation is not limited, and it can be carried out in a centrifuge. After separation, the primary crude potassium sulfate and the mother liquor of primary crude potassium sulfate are obtained. Test results indicate that the K₂O content in the obtained primary crude potassium sulfate ranges from 41.0% to 44.0% (by mass fraction, same below).

### S2, Second-Stage Reaction

The primary crude potassium sulfate, solid ammonium sulfate and solid potassium chloride are used as raw materials, after the raw materials are dissolved, a second-stage reaction is carried out in a solution system, and then crystallization and separation are conducted, so as to obtain a secondary crude potassium sulfate and a mother liquor of secondary crude potassium sulfate, wherein the secondary crude potassium sulfate is used for the third-stage reaction, and the mother liquor of secondary crude potassium sulfate is used for dissolving solid ammonium sulfate in the first-stage reaction. By adding solid ammonium sulfate and solid potassium chloride into the reactor vessel in two steps, the efficiency of reactor is improved, the reaction extent of potassium chloride and ammonium sulfate is increased, and the residence time of materials in the reactor vessel is shortened, so that the product quality is stable and improved to a certain extent. After the second-stage reaction, the secondary crude potassium sulfate with higher K₂O content can be obtained.

In some examples, the steps of the second-stage reaction include: mixing and dissolving the solid ammonium sulfate, the primary crude potassium sulfate and the mother liquor of potassium sulfate product to obtain the crystal slurry mixed solution, mixing the crystal slurry mixed solution with solid potassium chloride for the second-stage reaction, then cooling and crystallizing to precipitate the solid potassium sulfate, and then separating to obtain the secondary crude potassium sulfate and the mother liquor of secondary crude potassium sulfate. Here, the mother liquor of potassium sulfate product is obtained by crystallization and separation after the third-stage reaction, that is, the mother liquor of potassium sulfate product is obtained after separation of potassium sulfate product. Through the second-stage reaction, the primary crude potassium sulfate and unreacted potassium chloride in the mother liquor of potassium sulfate product can be fully reacted, so that the raw materials can be fully utilized, the consumption of raw materials can be reduced, and the quality of products can be improved to a certain extent. By recycling the mother liquor of the three reaction stages in the whole process, the purpose of zero emission can be achieved, and at the same time, the water consumption can be significantly reduced, so as to reduce the process cost.

It should be supplemented that the conventional second-stage reaction differs from the solution of adding solid ammonium sulfate and solid potassium chloride in two stages provided by the example of the present disclosure. The conventional second-step reaction is typically a mixed reaction of primary crude potassium sulfate and potassium chloride solution, while in the present disclosure, the solution is adding solid ammonium sulfate and solid potassium chloride in two stages. According to the present solution, the K₂O content in the product can be further improved and the chlorine content in the product can be reduced at the same time, so that the chlorine content is obviously lower than the current level, thereby expanding the application scope of potassium sulfate products.

In some examples, the molar ratio of solid ammonium sulfate to solid potassium chloride used in the second-stage reaction is 1:(1.8-2.8), for example, 1:1.8, 1:2.0, 1:2.2, 1:2.5, or 1:2.8, etc. By controlling the amounts of solid ammonium sulfate and solid potassium chloride in the second-stage reaction, the K₂O content in the secondary crude potassium sulfate can be further increased.

Furthermore, the mass ratio of the solid ammonium sulfate, the primary crude potassium sulfate and the mother liquor of potassium sulfate product is 1:(2.2-3.3):(4.8-6.2), for example, it can be 1:2.2:4.8, 1:2.5:5.0, 1:2.8:5.1, 1:3.2:6.0, etc. By adjusting the amounts of the primary crude potassium sulfate and the mother liquor of potassium sulfate product, the solid ammonium sulfate is fully dissolved, and the solid content of the solution can be maintained at an appropriate range, so as to facilitate the full reaction of ammonium sulfate and potassium chloride. Specifically, the dissolution process of solid ammonium sulfate can be carried out in a dissolution tank with a heating device, so as to provide the heat required for dissolution.

Furthermore, when preparing the crystal slurry mixed solution, the mother liquor of potassium sulfate product is used to dissolve the solid ammonium sulfate, and the crystal slurry mixed solution is heated to 60° C.-90° C., so as to rapidly and fully dissolve the solid ammonium sulfate. Specifically, the temperature of the dissolving water can be 60° C., 65° C., 70° C., 75° C., 80° C., 85° C., or 90° C., etc.

Furthermore, the crystal slurry mixed solution obtained after dissolution and solid potassium chloride are simultaneously added into the reactor, and stirred for reaction, wherein the temperature of the second-stage reaction is controlled at 60° C.-90° C., and the reaction duration is controlled at 1 h-3 h, so that ammonium sulfate and potassium chloride can fully react. Specifically, the second-stage reaction can be carried out in a reactor with a heating device to maintain the reaction temperature. The temperature of the reaction can be controlled at 60° C., 65° C., 70° C., 75° C., 80° C., 85° C., 90° C., etc., and the reaction duration can be controlled at 1.0 h, 1.5 h, 2.0 h, 2.5 h, 3.0 h, etc.

Furthermore, after the reaction is completed, the solution in the reactor is transferred into a crystallizer, cooled and crystallized, wherein the crystallization temperature is controlled at 30° C.-60° C. and the crystallization duration is controlled at 1 h-3 h, so that the potassium sulfate in the system can be fully precipitated. Specifically, the crystallization temperature can be controlled at 30° C., 35° C., 40° C., 45° C., 50° C., 55° C., 60° C., etc., and the crystallization duration can be controlled at 1.0 h, 1.5 h, 2.0 h, 2.5 h, 3.0 h, etc.

Furthermore, after the crystallization is completed, solid-liquid separation is carried out to obtain the secondary crude potassium sulfate and the mother liquor of secondary crude potassium sulfate. The way of solid-liquid separation is not limited, wherein a centrifuge can be used for separation, but it is not limited to this. The K₂O content in the secondary crude potassium sulfate prepared by the example of the present disclosure is 45.0%-48.0%.

### S3, Third-Stage Reaction

The secondary crude potassium sulfate obtained in step S2 is mixed with hot water at a temperature of 80° C.-98° C. for the third-stage reaction, and then the crystallization and separation are conducted after high-temperature reaction. The content of K₂O in the product can be further increased and the content of chlorine in the product can be reduced through the third-stage reaction.

In some examples, the secondary crude potassium sulfate and hot water with the required temperature are added into the reactor, and stirred for reaction, wherein the reaction temperature of the third-stage reaction is controlled at 60° C.-90° C. and the reaction duration is controlled at 0.5 h-2.0 h. After the reaction, the K₂O content in the product can be further improved. Specifically, the temperature of hot water for the third-stage reaction can be 80° C., 85° C., 90° C., 95° C., 98° C., etc., the reaction temperature of the third-stage reaction can be 60° C., 65° C., 70° C., 75° C., 80° C., 85° C., 90° C., etc., and the reaction duration can be 0.5 h, 1.0 h, 1.5 h, 2.0 h, etc. The reaction process can be carried out in a reactor with a heating device, so as to maintain the reaction temperature to meet the requirements.

In some examples, the mass ratio of the secondary crude potassium sulfate to hot water is controlled at 1:(0.8-1.2), for example, it can be 1:0.8, 1:0.9, 1:1.0, 1:1.1, 1:1.2, etc. By adjusting the amount of hot water, the solid content before the reaction can be made more suitable, so that the objective of high-temperature water washing can be achieved, and the reaction can be further conducted to increase the K₂O content of the product. In order to obtain a potassium sulfate product with higher K₂O content, the hot water and potassium chloride can be mixed first to obtain a potassium chloride solution with a mass fraction of 1%-30%, and then the potassium chloride solution is used to mix and react with the secondary crude potassium sulfate.

Furthermore, after the reaction with hot water is completed, the solution in the reactor is transferred into a crystallizer, cooled and crystallized, wherein the crystallization temperature is controlled at 30° C.-60° C. and the crystallization duration is controlled at 1 h-3 h, so that the potassium sulfate can be fully precipitated. Specifically, the crystallization temperature can be controlled at 30° C., 35° C., 40° C., 45° C., 50° C., 55° C., 60° C., etc., and the crystallization duration can be controlled at 1.0 h, 1.5 h, 2.0 h, 2.5 h, 3.0 h, etc.

Furthermore, after cooling and crystallization is completed, solid-liquid separation is carried out to obtain a wet potassium sulfate product and a mother liquor of potassium sulfate product, the wet potassium sulfate product is dried to obtain a potassium sulfate product with moisture content meeting the requirements, and the mother liquor of potassium sulfate product is used for dissolving the solid ammonium sulfates in the second-stage reaction. The way of solid-liquid separation is not limited, wherein a centrifuge can be used for separation, but it is not limited to this.

Through testing, the K₂O content of the potassium sulfate product prepared by the example of the present disclosure is 50.0 wt %-51.5 wt %, the chloride ion content is less than 0.3 wt %, the moisture content is less than 0.5 wt %, and the content of water insoluble matter is less than 0.05 wt %. Based on potassium sulfate products, the total yield of potassium oxide exceeds 75%; base on both potassium sulfate and NK fertilizer products, the total yield of potassium exceeds 99.9%.

It should be noted that the process provided by the example of the present disclosure has passed the pilot test, and the product meets the above requirements. Many of the processes mentioned in existing technologies for preparing potassium sulfate from ammonium sulfate and potassium chloride as raw materials cannot meet the claimed product requirements through industrial tests, such as the K₂O content not up to standard, and it is far below the product level obtained in the laboratory stage.

### S4, Preparing NK Fertilizer

The mother liquor of primary crude potassium sulfate is used to prepare the NK fertilizer byproducts. The mother liquor of primary crude potassium sulfate is further recycled to produce the NK fertilizer byproducts, thereby improving the utilization rate of raw materials and achieving zero emissions throughout the entire process.

In some examples, the mother liquor of primary crude potassium sulfate is evaporated and concentrated to obtain concentrated NK fertilizer mother liquor, the concentrated NK fertilizer mother liquor is crystallized and separated to obtain wet NK fertilizer product and NK fertilizer mother liquor, and the wet NK fertilizer product is dried to obtain NK fertilizer product, and the NK fertilizer mother liquor is returned to the evaporation and concentration stage for recycling. By further optimizing the process of preparing NK fertilizer byproducts, the utilization rate of raw materials is improved, at the same time, the K₂O content in the obtained NK fertilizer products is increased. The production technology of NK fertilizer byproducts is mature, the operation is simple, and the byproducts can be sold, thus reducing the cost and improving the economic benefit.

In some examples, the way of evaporation concentration is not limited, and the traditional triple-effect evaporation concentration process can be adopted, but it is not limited to this. The concentrated NK fertilizer mother liquor obtained after concentration is sent into a cooling crystallizer, where it is cooled to obtain a concentrated NK fertilizer crystal slurry solution. The concentrated NK fertilizer crystal slurry solution is then separated, so as to obtain the wet NK fertilizer product and NK fertilizer mother liquor. The way of separation is not limited, the way of centrifugation can be used, but it is not limited to this.

Through testing, the content of nutrients (N+K₂O) in the NK fertilizer product prepared in the example of the present disclosure exceeds 34%, and the moisture content is less than 1.0%.

The production equipment adopted by the process method provided by the example of the present disclosure can take various forms, for example, the reactor can take various forms, such as a bottom-agitated reactor, top-agitated reactor, jacketed reactor, or external circulation reactor, etc. The crystallizer can take various forms, such as a bottom-agitated crystallizer, top-agitated crystallizer, jacketed crystallizer, or external circulation crystallizer, etc. The evaporation system can also take various forms, such as a double-effect or triple-effect countercurrent evaporation system, or a double-effect or triple-effect cocurrent evaporation system, etc. The drying equipment can adopt various dryer types, such as a fluidized-bed (boiling-bed) dryer, tray dryer, or pneumatic dryer, etc.

A potassium sulfate product is provided in the example of the present disclosure, wherein the potassium sulfate product is obtained by the method provided by the example of the present disclosure. The potassium sulfate product has a K₂O content greater than 50 wt %, a chlorine content below 1 wt %, and a moisture content below 1.0 wt %, meeting the requirements of GBT 20406-2017 Requirements for Potassium Sulfate for Agricultural Use (specific requirements are listed in Table 1).

TABLE 1
Requirements for Potassium Sulfate for Agricultural Use

| | Powder Crystalline Form | | | Granular Form | |
|---|---|---|---|---|---|
| | Premium | Grade I | Qualified | Premium | Qualified |
| Parameter | product | product | product | product | product |
| Mass fraction of water-soluble | 52 | 50 | 45 | 50 | 45 |
| potassium oxide (K₂O)/% ≥ | | | | | |
| Mass fraction of sulfur (S)/% ≥ | 17.0 | 16.0 | 15.0 | 16.0 | 15.0 |
| Mass fraction of chloride ion | 1.5 | 2.0 | 2.0 | 1.5 | 2.0 |
| (Cl⁻)/% ≤ | | | | | |
| Mass fraction of Moisture ^{a} | 1.0 | 1.5 | 2.0 | 1.5 | 2.5 |
| (H₂O)/% ≤ | | | | | |
| Mass fraction of free acid | 1.0 | 1.5 | 2.0 | 2.0 | 2.0 |
| (based on H₂SO₄)/% ≤ | | | | | |
| Grain size ^{b} (Particle size: | — | — | — | 90 | 90 |
| 1.00 mm-4.75 mm or 3.35 mm- | | | | | |
| 5.60 mm)/% ≤ | | | | | |

^{a} indicates that the moisture is subject to the factory inspection data of the manufacturer.
^{b} indicates that if there are special requirements for particle size, it will be determined according to the agreement between the supply and demand sides.

A potash fertilizer is further provided in the example of the present disclosure, wherein the potash fertilizer includes the potassium sulfate product. Due to the high K₂O content and low chlorine content of the potassium sulfate products, the potash fertilizer has a wider range of applications.

The features and performance of the present disclosure are further described in detail below with reference to the examples.

### Example 1

A method for producing potassium sulfate by metathesis process was provided in the present example, wherein the method included the following steps.
(1) Solid ammonium sulfate, mother liquor of secondary crude potassium sulfate, and hot water at 95° C. were simultaneously added to a dissolution tank, where they were stirred and dissolved at 85° C., so as to obtain an ammonium sulfate solution. The mass ratio of solid ammonium sulfate, mother liquor of secondary crude potassium sulfate, and water was 1:2.2:0.8, and the mother liquor of potassium sulfate was derived from step (2). The ammonium sulfate solution and solid potassium chloride were simultaneously added to a reactor, where they were stirred and reacted at the reaction temperature of 80° C. with the reaction duration of 1 hour. The molar ratio of solid ammonium sulfate to solid potassium chloride was 1.0:1.8. The solution in the reactor was transferred into a crystallizer, where it was cooled and crystallized, and the crystallization temperature was 50° C. and the crystallization duration was 1 hour. After cooling crystallization, the solution was sent to a centrifuge and separated, so as to obtain the primary crude potassium sulfate and the mother liquor of primary crude potassium sulfate. The primary crude potassium sulfate was sent to step (2), while the mother liquor of primary crude potassium sulfate was sent to step (4) for the production of NK fertilizer byproducts.
(2) Solid ammonium sulfate, primary crude potassium sulfate, and mother liquor of potassium sulfate product (from step (3)) were mixed, and then stirred and dissolved at 85° C., so as to prepare a crystal slurry mixed solution. The mass ratio of solid ammonium sulfate, primary crude potassium sulfate and mother liquor of potassium sulfate product was 1:2.7:5.0. The crystal slurry mixed solution and solid potassium chloride were simultaneously added to a reactor, where they were stirred and reacted at the reaction temperature of 80° C. with the reaction duration of 1 hour. The molar ratio of solid ammonium sulfate to solid potassium chloride added in step (2) was 1:2.5. The solution from the reactor was sent to a crystallizer, where it was cooled and crystallized, the crystallization temperature was 50° C. and the crystallization duration was 1 hour. After cooling crystallization, the solution was sent to a centrifuge and separated, so as to obtain the secondary crude potassium sulfate and the mother liquor of secondary crude potassium sulfate. The secondary crude potassium sulfate was sent to step (3), while the mother liquor of secondary crude potassium sulfate was recycled.
(3) The secondary crude potassium sulfate obtained from step (2) and hot water at 95° C. were mixed at a mass ratio of 1:0.9 and simultaneously added to a reactor, where they were stirred and reacted, wherein the reaction temperature was 80° C. and the reaction duration was 1 hour. The solution from the reactor was sent to a crystallizer, where it was cooled and crystallized, the crystallization temperature was 50° C. and the crystallization duration was 1 hour. After cooling crystallization, the solution was sent to a centrifuge and separated, so as to obtain the wet potassium sulfate product and the mother liquor of potassium sulfate product. The wet potassium sulfate product was dried, while the mother liquor of potassium sulfate product was recycled. The wet potassium sulfate product was dried in a dryer, so as to obtain the potassium sulfate product, wherein the drying temperature was controlled at 110° C., and the drying duration was controlled at 0.5 h-1 h.

Through testing, the K₂O content of potassium sulfate product reached 50.8% and the moisture content was 0.3%. Based on potassium sulfate products, the total yield of potassium oxide reached 75.5%. Through the dissolution testing, it was confirmed that the potassium sulfate product can be completely dissolved, with the content of water insoluble matter measured at 0.03% (the testing referred to GB 6549-2011 “Determination of content of water insoluble matter in potassium chloride”). Chloride ion content in the potassium sulfate product was measured, and the results showed that the chloride ion content was 0.08%.
(4) The mother liquor of primary crude potassium sulfate obtained from step (1) was subjected to the triple-effect evaporation and concentration, so as to obtain the concentrated NK fertilizer mother liquor. The concentrated NK fertilizer mother liquor was sent to a cooling crystallizer, where it was cooled, so as to obtain the concentrated NK fertilizer crystal slurry solution. The concentrated NK fertilizer crystal slurry solution was separated to obtain the wet NK fertilizer product and the NK fertilizer mother liquor. The NK fertilizer mother liquor was returned to the triple-effect evaporation and concentration stage for recycling. The wet NK fertilizer product was dried in a dryer, so as to obtain the NK fertilizer product.

Through testing, the total N content of NK fertilizer products exceeded 17.4%, the K₂O content exceeded 17.9%, and the moisture content was 0.4%.

Example 2 (Compared to Example 1, the reaction temperature of the dissolution tank and reactor was increased.)

A method for producing potassium sulfate by metathesis process was provided in the present example, wherein the method included the following steps.
(1) Solid ammonium sulfate, mother liquor of secondary crude potassium sulfate, and hot water at 95° C. were simultaneously added to a dissolution tank, where they were stirred and dissolved at 95° C., so as to obtain an ammonium sulfate solution. The mass ratio of solid ammonium sulfate, mother liquor of secondary crude potassium sulfate, and water was 1:2.2:0.8, and the mother liquor of potassium sulfate was derived from step (2). The ammonium sulfate solution and solid potassium chloride were simultaneously added to a reactor, where they were stirred and reacted at the reaction temperature of 95° C. with the reaction duration of 1 hour. The molar ratio of solid ammonium sulfate to solid potassium chloride was 1.0:1.8. The solution in the reactor was transferred into a crystallizer, where it was cooled and crystallized, and the crystallization temperature was 50° C. and the crystallization duration was 1 hour. After cooling crystallization, the solution was sent to a centrifuge and separated, so as to obtain the primary crude potassium sulfate and the mother liquor of primary crude potassium sulfate. The primary crude potassium sulfate was sent to step (2), while the mother liquor of primary crude potassium sulfate was sent to step (4) for the production of NK fertilizer byproducts.
(2) Solid ammonium sulfate, primary crude potassium sulfate, and mother liquor of potassium sulfate product (from step (3)) were mixed, and then stirred and dissolved at 95° C., so as to prepare a crystal slurry mixed solution. The mass ratio of solid ammonium sulfate, primary crude potassium sulfate and mother liquor of potassium sulfate product was 1:2.7:5.0. The crystal slurry mixed solution and solid potassium chloride were simultaneously added to a reactor, where they were stirred and reacted at the reaction temperature of 95° C. with the reaction duration of 1 hour. The molar ratio of solid ammonium sulfate to solid potassium chloride added in step (2) was 1:2.5. The solution from the reactor was sent to a crystallizer, where it was cooled and crystallized, the crystallization temperature was 50° C. and the crystallization duration was 1 hour. After cooling crystallization, the solution was sent to a centrifuge and separated, so as to obtain the secondary crude potassium sulfate and the mother liquor of secondary crude potassium sulfate. The secondary crude potassium sulfate was sent to step (3), while the mother liquor of secondary crude potassium sulfate was recycled.
(3) The secondary crude potassium sulfate obtained from step (2) and hot water at 95° C. were mixed at a mass ratio of 1:0.9 and simultaneously added to a reactor, where they were stirred and reacted, wherein the reaction temperature was 95° C. and the reaction duration was 1 hour. The solution from the reactor was sent to a crystallizer, where it was cooled and crystallized, and the crystallization temperature was 50° C. and the crystallization duration was 1 hour. After cooling crystallization, the solution was sent to a centrifuge and separated, so as to obtain the wet potassium sulfate product and the mother liquor of potassium sulfate product. The wet potassium sulfate product was dried, while the mother liquor of potassium sulfate product was recycled.

The wet potassium sulfate product was dried in a dryer, so as to obtain the potassium sulfate product, wherein the drying temperature was controlled at 110° C., and the drying duration was controlled at 0.5 h-1 h.

Through testing, the K₂O content of potassium sulfate product reached 51.1% and the moisture content was 0.3%. Based on potassium sulfate products, the total yield of potassium oxide reached 75.2%. Through the dissolution testing, it was confirmed that the potassium sulfate product can be completely dissolved, with the content of water insoluble matter measured at 0.03% (the testing referred to GB 6549-2011 “Determination of content of water insoluble matter in potassium chloride”). Chloride ion content in the potassium sulfate product was measured, and the results showed that the chloride ion content was 0.06%.
(4) This step was the same as step (4) in Example 1.

Through testing, the total N content of NK fertilizer products exceeded 17.5%, the K₂O content exceeded 17.6%, and the moisture content was 0.4%.

### Example 3 (Compared to Example 1, the Crystallization Temperature of the Crystallizer was Decreased.)

A method for producing potassium sulfate by metathesis process was provided in the present example, wherein the method included the following steps.
(1) Solid ammonium sulfate, mother liquor of secondary crude potassium sulfate, and hot water at 95° C. were simultaneously added to a dissolution tank, where they were stirred and dissolved at 85° C., so as to obtain an ammonium sulfate solution. The mass ratio of solid ammonium sulfate, mother liquor of secondary crude potassium sulfate, and water was 1:2.1:0.8, and the mother liquor of potassium sulfate was derived from step (2). The ammonium sulfate solution and solid potassium chloride were simultaneously added to a reactor, where they were stirred and reacted at the reaction temperature of 80° C. with the reaction duration of 1 hour. The molar ratio of solid ammonium sulfate to solid potassium chloride was 1.0:1.8. The solution in the reactor was transferred into a crystallizer, where it was cooled and crystallized, and the crystallization temperature was 40° C. and the crystallization duration was 1 hour. After cooling crystallization, the solution was sent to a centrifuge and separated, so as to obtain the primary crude potassium sulfate and the mother liquor of primary crude potassium sulfate. The primary crude potassium sulfate was sent to step (2), while the mother liquor of primary crude potassium sulfate was sent to step (4) for the production of NK fertilizer byproducts.
(2) Solid ammonium sulfate, primary crude potassium sulfate, and mother liquor of potassium sulfate product (from step (3)) were mixed, and then stirred and dissolved at 85° C., so as to prepare a crystal slurry mixed solution. The mass ratio of solid ammonium sulfate, primary crude potassium sulfate and mother liquor of potassium sulfate product was 1:2.7:4.8. The crystal slurry mixed solution and solid potassium chloride were simultaneously added to a reactor, where they were stirred and reacted at the reaction temperature of 80° C. with the reaction duration of 1 hour. The molar ratio of solid ammonium sulfate to solid potassium chloride added in step (2) was 1:2.5. The solution from the reactor was sent to a crystallizer, where it was cooled and crystallized, the crystallization temperature was 40° C. and the crystallization duration was 1 hour. After cooling crystallization, the solution was sent to a centrifuge and separated, so as to obtain the secondary crude potassium sulfate and the mother liquor of secondary crude potassium sulfate. The secondary crude potassium sulfate was sent to step (3), while the mother liquor of secondary crude potassium sulfate was recycled.
(3) The secondary crude potassium sulfate obtained from step (2) and hot water at 95° C. were mixed at a mass ratio of 1:0.9 and simultaneously added to a reactor, where they were stirred and reacted, wherein the reaction temperature was 80° C. and the reaction duration was 1 hour. The solution from the reactor was sent to a crystallizer, where it was cooled and crystallized, and the crystallization temperature was 40° C. and the crystallization duration was 1 hour. After cooling crystallization, the solution was sent to a centrifuge and separated, so as to obtain the wet potassium sulfate product and the mother liquor of potassium sulfate product. The wet potassium sulfate product was dried, while the mother liquor of potassium sulfate product was recycled. The wet potassium sulfate product was dried in a dryer, so as to obtain the potassium sulfate product, wherein the drying temperature was controlled at 110° C., and the drying duration was controlled at 0.5 h-1 h.

Through testing, the K₂O content of potassium sulfate product reached 50.5% and the moisture content was 0.3%. Based on potassium sulfate products, the total yield of potassium oxide reached 76.5%. Through the dissolution testing, it was confirmed that the potassium sulfate product can be completely dissolved, with the content of water insoluble matter measured at 0.04% (the testing referred to GB 6549-2011 “Determination of content of water insoluble matter in potassium chloride”). Chloride ion content in the potassium sulfate product was measured, and the results showed that the chloride ion content was 0.25%.
(4) This step was the same as step (4) in Example 1.

Through testing, the total N content of NK fertilizer products exceeded 17.4%, the K₂O content exceeded 17.9%, and the moisture content was 0.4%.

### Example 4 (Compared to Example 1, the Ratio of Raw Materials (Ammonium Sulfate and Potassium Chloride) in Steps 1 and 2 was Changed.)

A method for producing potassium sulfate by metathesis process was provided in the present example, wherein the method included the following steps.
(1) Solid ammonium sulfate, mother liquor of secondary crude potassium sulfate, and hot water at 95° C. were simultaneously added to a dissolution tank, where they were stirred and dissolved at 85° C., so as to obtain an ammonium sulfate solution. The mass ratio of solid ammonium sulfate, mother liquor of secondary crude potassium sulfate, and water was 1:2.3:0.8, and the mother liquor of potassium sulfate was derived from step (2). The ammonium sulfate solution and solid potassium chloride were simultaneously added to a reactor, where they were stirred and reacted at the reaction temperature of 80° C. with the reaction duration of 1 hour. The molar ratio of solid ammonium sulfate to solid potassium chloride was 1.0:2.0. The solution in the reactor was transferred into a crystallizer, where it was cooled and crystallized, and the crystallization temperature was 50° C. and the crystallization duration was 1 hour. After cooling crystallization, the solution was sent to a centrifuge and separated, so as to obtain the primary crude potassium sulfate and the mother liquor of primary crude potassium sulfate. The primary crude potassium sulfate was sent to step (2), while the mother liquor of primary crude potassium sulfate was sent to step (4) for the production of NK fertilizer byproducts.
(2) Solid ammonium sulfate, primary crude potassium sulfate, and mother liquor of potassium sulfate product (from step (3)) were mixed, and then stirred and dissolved at 85° C., so as to prepare a crystal slurry mixed solution. The mass ratio of solid ammonium sulfate, primary crude potassium sulfate and mother liquor of potassium sulfate product was 1:2.7:5.2. The crystal slurry mixed solution and solid potassium chloride were simultaneously added to a reactor, where they were stirred and reacted at the reaction temperature of 80° C. with the reaction duration of 1 hour. The molar ratio of solid ammonium sulfate to solid potassium chloride added in step (2) was 1:2.7. The solution from the reactor was sent to a crystallizer, where it was cooled and crystallized, the crystallization temperature was 50° C. and the crystallization duration was 1 hour. After cooling crystallization, the solution was sent to a centrifuge and separated, so as to obtain the secondary crude potassium sulfate and the mother liquor of secondary crude potassium sulfate. The secondary crude potassium sulfate was sent to step (3), while the mother liquor of secondary crude potassium sulfate was recycled.
(3) This step was the same as step (3) in Example 1.

Through testing, the K₂O content of potassium sulfate product reached 50.6% and the moisture content was 0.3%. Based on potassium sulfate products, the total yield of potassium oxide reached 75.1%. Through the dissolution testing, it was confirmed that the potassium sulfate product can be completely dissolved, with the content of water insoluble matter measured at 0.04% (the testing referred to GB 6549-2011 “Determination of content of water insoluble matter in potassium chloride”). Chloride ion content in the potassium sulfate product was measured, and the results showed that the chloride ion content was 0.28%.
(4) This step was the same as step (4) in Example 1.

Through testing, the total N content of NK fertilizer products exceeded 17.2%, the K₂O content exceeded 18.2%, and the moisture content was 0.4%.

### Example 5: (Compared to Example 1, the Amount of Hot Water in Step 3 was Increased, and the Mass Ratio of Secondary Crude Potassium Sulfate and Hot Water was Increased.)

A method for producing potassium sulfate by metathesis process was provided in the present example, wherein the method included the following steps.
(1) This step was the same as step (1) in Example 1.
(2) This step was the same as step (2) in Example 1.
(3) The secondary crude potassium sulfate obtained from step (2) and hot water at 95° C. were mixed at a mass ratio of 1:1.2 and simultaneously added to a reactor, where they were stirred and reacted, wherein the reaction temperature was 80° C. and the reaction duration was 1 hour. The solution from the reactor was sent to a crystallizer, where it was cooled and crystallized, and the crystallization temperature was 50° C. and the crystallization duration was 1 hour. After cooling crystallization, the solution was sent to a centrifuge and separated, so as to obtain the wet potassium sulfate product and the mother liquor of potassium sulfate product. The wet potassium sulfate product was dried, while the mother liquor of potassium sulfate product was recycled. The wet potassium sulfate product was dried in a dryer, so as to obtain the potassium sulfate product, wherein the drying temperature was controlled at 110° C., and the drying duration was controlled at 0.5 h-1 h.

Through testing, the K₂O content of potassium sulfate product reached 51.5% and the moisture content was 0.3%. Based on potassium sulfate products, the total yield of potassium oxide reached 75.1%. Through the dissolution testing, it was confirmed that the potassium sulfate product can be completely dissolved, with the content of water insoluble matter measured at 0.02% (the testing referred to GB 6549-2011 “Determination of content of water insoluble matter in potassium chloride”). Chloride ion content in the potassium sulfate product was measured, and the results showed that the chloride ion content was 0.04%.
(4) This step was the same as step (4) in Example 1.

Through testing, the total N content of NK fertilizer products exceeded 17.3%, the K₂O content exceeded 17.7%, and the moisture content was 0.4%.

### Example 6: (Compared to Example 1, Potassium Chloride was First Added to the Clean Water in Step (3) to Prepare a Potassium Chloride Solution, and then the Secondary Crude Potassium Sulfate was Washed.)

A method for producing potassium sulfate by metathesis process was provided in the present example, wherein the method included the following steps.
(1) This step was the same as step (1) in Example 1.
(2) This step was the same as step (2) in Example 1.
(3) The secondary crude potassium sulfate obtained from step (2) and hot water at 95° C. were mixed at a mass ratio of 1:0.9. Hot water was first added into the dissolution tank, and then solid potassium chloride was added to prepare 85° C. potassium chloride solution with mass fraction of 10%. The potassium chloride solution prepared in advance and the secondary crude potassium sulfate were simultaneously added to a reactor, where they were stirred and reacted, wherein the reaction temperature was 80° C. and the reaction duration was 1 hour. The solution from the reactor was sent to a crystallizer, where it was cooled and crystallized, and the crystallization temperature was 50° C. and the crystallization duration was 1 hour. After cooling crystallization, the solution was sent to a centrifuge and separated, so as to obtain the wet potassium sulfate product and the mother liquor of potassium sulfate product. The wet potassium sulfate product was dried, while the mother liquor of potassium sulfate product was recycled. The wet potassium sulfate product was dried in a dryer, so as to obtain the potassium sulfate product, wherein the drying temperature was controlled at 110° C., and the drying duration was controlled at 0.5 h-1 h.

Through testing, the K₂O content of potassium sulfate product reached 51.2% and the moisture content was 0.3%. Based on potassium sulfate products, the total yield of potassium oxide reached 75.2%. Through the dissolution testing, it was confirmed that the potassium sulfate product can be completely dissolved, with the content of water insoluble matter measured at 0.05% (the testing referred to GB 6549-2011 “Determination of content of water insoluble matter in potassium chloride”). Chloride ion content in the potassium sulfate product was measured, and the results showed that the chloride ion content was 0.39%.
(4) This step was the same as step (4) in Example 1.

Through testing, the total N content of NK fertilizer products exceeded 17.2%, the K₂O content exceeded 18.1%, and the moisture content was 0.4%.

### Comparative Example 1

The main difference from Example 1 was that a two-step reaction method was adopted, wherein the step (3) was omitted, and both solid ammonium sulfate and solid potassium chloride were added in the first step. In step (2), a KCl solution with a concentration of 10% was introduced for the reaction.

The specific steps were as follows.
(1) Solid ammonium sulfate, mother liquor of potassium sulfate, and hot water at 95° C. were simultaneously added to a dissolution tank, where they were stirred and dissolved at 85° C., so as to obtain an ammonium sulfate solution. The mass ratio of solid ammonium sulfate, mother liquor of potassium sulfate product, and water was 1:2.2:0.8, and the mother liquor of potassium sulfate product was derived from step (2). The ammonium sulfate solution and solid potassium chloride were simultaneously added to a reactor, where they were stirred and reacted at a reaction temperature of 80° C. with a reaction duration of 1 hour. The molar ratio of solid ammonium sulfate to solid potassium chloride was 1.0:2.0. The solution in the reactor was transferred into a crystallizer, where it was cooled and crystallized, the crystallization temperature was 50° C. and the crystallization duration was 1 hour. After cooling crystallization, the solution was sent to a centrifuge and separated, so as to obtain the crude potassium sulfate and the mother liquor of crude potassium sulfate. The crude potassium sulfate was sent to step (2), while the mother liquor of crude potassium sulfate was sent to prepare the NK fertilizer byproducts.
(2) The crude potassium sulfate obtained from step (1) and hot water at 95° C. were mixed at a mass ratio of 1:1.4. Hot water was first added into the dissolution tank, and then solid potassium chloride was added to prepare 85° C. potassium chloride solution with a mass fraction of 10%. Then the crude potassium sulfate was added to a KCl solution with a concentration of 10% and reacted at 80° C. for 1 hour. The solution from the reactor was sent to a crystallizer, where it was cooled and crystallized, the crystallization temperature was 50° C. and the crystallization duration was 1 hour. After cooling crystallization, the solution was sent to a centrifuge and separated, so as to obtain the wet potassium sulfate product and the mother liquor of potassium sulfate product. The potassium sulfate was dried in a dryer, so as to obtain the potassium sulfate product, wherein the drying temperature was controlled at 110° C., and the drying duration was controlled at 0.5 h-1 h. The mother liquor of potassium sulfate product was recycled.

Through testing, the K₂O content of potassium sulfate product reached 50.1%. Based on potassium sulfate products, the total yield of potassium oxide reached 70.2%. Through the dissolution testing, it was confirmed that the potassium sulfate product can be completely dissolved, with the content of water insoluble matter measured at 0.05% (the testing referred to GB 6549-2011 “Determination of content of water insoluble matter in potassium chloride”). Chloride ion content in the potassium sulfate product was measured, and the results showed that the chloride ion content was 0.45%.

By adopting the two-step method, although the K₂O content of the product can reach the 50.0% requirement for Grade I potassium sulfate products specified in the national standard, but due to the high water consumption of the two-step method, the total yield of potassium oxide is relatively low.

### Comparative Example 2

The main difference from Example 1 was that a two-step reaction method was adopted, wherein the step (3) was omitted, and both solid ammonium sulfate and solid potassium chloride were added in the first step. In step (2), the crude potassium sulfate was washed with clean water directly.

The specific steps were as follows.
(1) Solid ammonium sulfate, mother liquor of potassium sulfate, and hot water at 95° C. were simultaneously added to a dissolution tank, where they were stirred and dissolved at 85° C., so as to obtain an ammonium sulfate solution. The mass ratio of solid ammonium sulfate, mother liquor of potassium sulfate product, and water was 1:2.2:0.8, and the mother liquor of potassium sulfate product was derived from step (2). The ammonium sulfate solution and solid potassium chloride were simultaneously added to a reactor, where they were stirred and reacted at the reaction temperature of 80° C. with the reaction duration of 1 hour. The molar ratio of solid ammonium sulfate to solid potassium chloride was 1.0:2.0. The solution in the reactor was transferred into a crystallizer, where it was cooled and crystallized, and the crystallization temperature was 50° C. and the crystallization duration was 1 hour. After cooling crystallization, the solution was sent to a centrifuge and separated, so as to obtain the crude potassium sulfate and the mother liquor of crude potassium sulfate. The crude potassium sulfate was sent to step (2), while the mother liquor of crude potassium sulfate was sent to prepare the NK fertilizer byproducts.
(2) The crude potassium sulfate obtained from step (1) and hot water at 95° C. were mixed at a mass ratio of 1:1.4. Hot water was first added into the dissolution tank, and then the crude potassium sulfate was added to react at 80° C. for 1 hour. The solution from the reactor was sent to a crystallizer, where it was cooled and crystallized, the crystallization temperature was 50° C. and the crystallization duration was 1 hour. After cooling crystallization, the solution was sent to a centrifuge and separated, so as to obtain the wet potassium sulfate product and the mother liquor of potassium sulfate product. The potassium sulfate was dried in a dryer, so as to obtain the potassium sulfate product, wherein the drying temperature was controlled at 110° C., and the drying duration was controlled at 0.5 h-1 h. The mother liquor of potassium sulfate product was recycled.

Through testing, the K₂O content of potassium sulfate product reached 48.2%. Based on potassium sulfate products, the total yield of potassium oxide reached 69.5%. Through the dissolution testing, it was confirmed that the potassium sulfate product can be completely dissolved, with the content of water insoluble matter measured at 0.06% (the testing referred to GB 6549-2011 “Determination of content of water insoluble matter in potassium chloride”). Chloride ion content in the potassium sulfate product was measured, and the results showed that the chloride ion content was 0.45%.

By adopting the two-step method, the K₂O content of the product cannot reach the 50.0% requirement for Grade I potassium sulfate products specified in the national standard. Moreover, due to the high water consumption of the two-step method, the total yield of potassium oxide is relatively low.

### Comparative Example 3

The only difference from Example 1 was that, in step (3), instead of using high-temperature water for washing, low-temperature water was used for washing, followed by direct separation and drying.

The specific steps were as follows.
(1) This step was the same as step (1) in Example 1.
(2) This step was the same as step (2) in Example 1.
(3) The secondary crude potassium sulfate obtained from step (2) and hot water at 60° C. were mixed at a mass ratio of 1:0.9, washed with water at 50° C., and after 1 hour of reaction, the solution was sent to a centrifuge and separated, so as to obtain the wet potassium sulfate product and the mother liquor of potassium sulfate product. The wet potassium sulfate product was dried, while the mother liquor of potassium sulfate product was recycled. The crystals were dried (drying temperature and duration were the same as in Example 1) to obtain the potassium sulfate product.

Through testing, the K₂O content of potassium sulfate product reached 49.1%. Based on potassium sulfate products, the total yield of potassium oxide reached 76.1%. Through the dissolution testing, it was confirmed that the potassium sulfate product can be completely dissolved, with the content of water insoluble matter measured at 0.07% (the testing referred to GB 6549-2011 “Determination of content of water insoluble matter in potassium chloride”). Chloride ion content in the potassium sulfate product was measured, and the results showed that the chloride ion content was 0.42%.

By adopting the low-temperature washing, the K₂O content of the product cannot reach the 50.0% requirement for Grade I potassium sulfate products specified in the national standard.

### Comparative Example 4

The only difference from Example 1 was that: in step (3), crystallization was not performed after washing with hot water, separation was performed directly, followed by drying.

The specific steps were as follows.
(1) This step was the same as step (1) in Example 1.
(2) This step was the same as step (2) in Example 1.
(3) The secondary crude potassium sulfate obtained from step (2) and hot water at 95° C. were mixed at a mass ratio of 1:0.9, washed with water at 80° C., and after 1 hour of reaction, the solution was sent to a centrifuge and separated, so as to obtain the wet potassium sulfate product and the mother liquor of potassium sulfate product. The wet potassium sulfate product was dried, while the mother liquor of potassium sulfate product was recycled. The crystals were dried (drying temperature and duration were the same as in Example 1) to obtain the potassium sulfate product.

Through testing, the K₂O content of potassium sulfate product reached 51.3%. Based on potassium sulfate products, the total yield of potassium oxide reached 67%. Through the dissolution testing, it was confirmed that the potassium sulfate product can be completely dissolved, with the content of water insoluble matter measured at 0.04% (the testing referred to GB 6549-2011 “Determination of content of water insoluble matter in potassium chloride”). Chloride ion content in the potassium sulfate product was measured, and the results showed that the chloride ion content was 0.06%.

According to the present method, the product quality is good after high-temperature washing, but the total yield of potassium oxide is relatively low without low-temperature crystallization.

### Comparative Example 5

The only difference from Example 1 was that step (2) and step (3) were not performed, and instead, a conventional one-step reaction process was adopted, wherein the ammonium sulfate solution reacted with solid potassium chloride.

The specific steps were as follows.
(1) Solid ammonium sulfate and hot water at 95° C. were simultaneously added to a dissolution tank, where they were stirred and dissolved, so as to obtain an ammonium sulfate solution. The mass ratio of solid ammonium sulfate to water was 1:2.4. The ammonium sulfate solution and solid potassium chloride were simultaneously added to a reactor, where they were stirred and reacted at a reaction temperature of 80° C. with a reaction duration of 1 hour. The molar ratio of solid ammonium sulfate to solid potassium chloride was 1.0:2.0.
(2) The solution in the reactor was transferred into a crystallizer, where it was cooled and crystallized, and the crystallization temperature was 50° C. and the crystallization duration was 1 hour. After cooling crystallization, the solution was sent to a centrifuge and separated, so as to obtain the wet potassium sulfate product and the mother liquor of potassium sulfate.
(3) The wet potassium sulfate product was dried: the crystals were dried (drying temperature and duration were the same as in Example 1) to obtain the potassium sulfate product.

Through testing, the K₂O content of potassium sulfate product reached 44.5%. Based on potassium sulfate products, the total yield of potassium oxide reached 69.5%. Through the dissolution testing, it was confirmed that the potassium sulfate product can be completely dissolved, with the content of water insoluble matter measured at 0.09% (the testing referred to GB 6549-2011 “Determination of content of water insoluble matter in potassium chloride”). Chloride ion content in the potassium sulfate product was measured and the results showed that the chloride ion content was 1.9%.

Using the conventional one-step method, wherein ammonium sulfate solution reacts with solid potassium chloride, the product quality is poor, with low K₂O content and high chloride ion content. Further purification is needed to prepare products that meet the national standard requirements of potassium sulfate.

### Comparative Example 6

The only difference from Example 1 was that step (2) and step (3) were not performed, and instead, a conventional one-step reaction process was adopted, wherein the ammonium sulfate solution reacted with potassium chloride solution.

The specific steps were as follows.
(1) Solid ammonium sulfate and hot water at 95° C. were simultaneously added to a dissolution tank, where they were stirred and dissolved, so as to obtain an ammonium sulfate solution, wherein the mass ratio of solid ammonium sulfate to water was 1:1.36. Solid potassium chloride and hot water at 95° C. were simultaneously added to a dissolution tank, where they were stirred and dissolved, so as to obtain a potassium chloride solution, wherein the mass ratio of solid potassium chloride to water was 1:2.28. The ammonium sulfate solution and potassium chloride solution were simultaneously added to a reactor, where they were stirred and reacted at the reaction temperature of 80° C. with the reaction duration of 1 hour. The molar ratio of solid ammonium sulfate to solid potassium chloride was 1.0:2.0.
(2) The solution in the reactor was transferred into a crystallizer, where it was cooled and crystallized, the crystallization temperature was 50° C. and the crystallization duration was 1 hour. After cooling crystallization, the solution was sent to a centrifuge and separated, so as to obtain the wet potassium sulfate product and the mother liquor of potassium sulfate. The wet potassium sulfate product was dried: the crystals were dried (drying temperature and duration were the same as in Example 1) to obtain the potassium sulfate product.

Through testing, the K₂O content of potassium sulfate product reached 50.5%. Based on potassium sulfate products, the total yield of potassium oxide reached 36.8%. Through the dissolution testing, it was confirmed that the potassium sulfate product can be completely dissolved, with the content of water insoluble matter measured at 0.02% (the testing referred to GB 6549-2011 “Determination of content of water insoluble matter in potassium chloride”). Chloride ion content in the potassium sulfate product was measured, and the results showed that the chloride ion content was 0.30%.

Using the one-step method, wherein ammonium sulfate solution reacts with potassium chloride solution, the product quality can reach the 50.0% requirement for Grade I potassium sulfate products specified in the national standard, but the yield of potassium oxide is extremely low.

To sum up, according to the method for producing potassium sulfate by the metathesis process, the potassium sulfate product and the potash fertilizer provided by the example of the present disclosure, potassium chloride and ammonium sulfate are used as raw materials, through three steps of preparation, the potassium sulfate product with K₂O content greater than 50% is obtained.

The product exhibits the following advantages.
(1) The prepared potassium sulfate product achieves a potassium oxide (K₂O) content greater than 50 wt % (50%-52%), chlorine content below 1 wt % (can reach below 0.3%), moisture content below 1.0 wt %, and content of water insoluble matter below 0.05%, exceeding the requirements for Grade I crystalline potassium sulfate for agricultural use under the national standard GB/T 20406-2017.
(2) Based on the main potassium sulfate product, the yield of potassium oxide exceeds 75%; calculated by potassium sulfate products and NK fertilizer, the yield of potassium oxide reached over 99.9%. The nutrient (N+K₂O) content of byproduct NK fertilizer exceeds 34%, meeting market demand and can be directly sold as a binary compound fertilizer.
(3) The potassium sulfate product prepared by the present disclosure is completely water soluble, and the water insoluble matter is less than 0.05%. At present, the potassium sulfate products produced by the Mannheim method on the market contain approximately 0.2%-0.5% water insoluble matter due to the addition of limestone powder (calcium carbonate and calcium hydroxide) to neutralize unreacted sulfuric acid during production, generating calcium-containing insoluble matter. These products cannot achieve full water solubility, and using them for spray fertilization will clog the sprayer and eventually block the pipes after a long time. Achieving full water solubility would require using potassium hydroxide or potassium carbonate for sulfuric acid neutralization, significantly increasing costs. The potassium sulfate product prepared by the present disclosure can achieve the effect of full water solubility, and has good conveying and spraying effects, thus making it more suitable for the application of spraying fertilization.
(4) The chloride ion content of the potassium sulfate product in the process of the present disclosure is low. Now, the chloride ion content of the mainstream potassium sulfate product in the market is 1.0%-2.0%, while the chloride ion content of the potassium sulfate product produced by the present disclosure can reach below 0.3%, representing more than 70% reduction of the chloride ion content. The chloride ion content exceeds the requirements for premium-grade crystalline potassium sulfate for agricultural use under the national standard GB/T 20406-2017. Although chlorine is an essential trace element for plants, high levels of chloride ions can be harmful to many chlorine-sensitive crops. At the same time, large amounts of chloride ions entering the soil can accelerate soil salinization. Potassium sulfate is suitable for chlorine-sensitive plants and arid regions with little rain. Therefore, potassium sulfate with low chlorine content is suitable for a wider range of crops and further has a better protective effect on the soil.
(5) The dried product of potassium sulfate prepared by the present disclosure has uniform grain size distribution, excellent flowability without requiring anti-caking agents, maintaining good looseness and flow characteristics after long-term storage.
(6) The byproduct of the process of the present disclosure is NK fertilizer, the total content of total nutrients (N+K₂O) of NK fertilizer exceeds 34%, and the moisture content is below 1.0%. The production technology of byproducts is mature, and NK fertilizer can be directly sold as a binary compound fertilizer, or a ternary compound fertilizer can be produced by adding phosphorus (P), thus achieving the effects of reducing production cost and improving economic benefits. However, the conventional Mannheim method produces hydrochloric acid as a byproduct, but the sales range of hydrochloric acid is restricted, resulting in low economic efficiency for the product.

The preparation method and process exhibit the following advantages.
(1) In the method provided by the present disclosure, potassium chloride and ammonium sulfate are used as raw materials, and a metathesis reaction is adopted to prepare potassium sulfate product with K₂O content greater than 50.0% through a three-step method, so that continuous, large-scale and industrialized production has been realized. Each step of the present process is simple. Compared with the existing mature industrial technology (the technology of producing potassium sulfate by Mannheim method), the production devices are all atmospheric pressure equipment, making it is safe to operate; the reaction process are all carried out at a relatively low temperature without strong acid or alkali environments, making the equipment is not easy to be corroded and the emission of toxic gas be avoided, so that the present process is more energy-efficient and environmentally friendly.
(2) Compared with the traditional two-step method, the three-step method adopted by the present disclosure has more advantages.

Two-step method: in the first step, ammonium sulfate solution reacts with solid potassium chloride to prepare crude potassium sulfate (K₂O content is between 42%-44%), and in the second step, hot water or potassium chloride solution (mass fraction of potassium chloride in solution is between 1%-30%) is used for washing the potassium sulfate product after the reaction. When the ratio of crude potassium sulfate to water is 1:0.9-1.0, the K₂O content of the prepared potassium sulfate product is about 49.0%. When the ratio of crude potassium sulfate to water is increased to 1:1.4-1.5, the potassium sulfate product with K₂O content of about 50.1% can be prepared. The preparation of 1.0 tons of potassium sulfate products by the two-step method requires the introduction of about 2.4 tons of fresh water.

Three-step method: ammonium sulfate and potassium chloride are added in two steps, and in the third step, clean water or potassium chloride solution (the mass fraction of potassium chloride in the solution is between 1%-20%) is used for washing the potassium sulfate product after the reaction. The K₂O content of the primary crude potassium sulfate prepared in the first step is 42.0%-43.5%, and the K₂O content of the secondary crude potassium sulfate prepared in the second step is 45.0%-47.0%. Since the K₂O content of the secondary crude potassium sulfate has reached above 45.0%, in the third step, a potassium sulfate product with a K₂O content of above 50.5% can be obtained by washing with 0.9 times of hot water, and a potassium sulfate product with a K₂O content above 51.0% can be obtained by slightly increasing the washing water amount to 1.1 times. By adopting step-by-step feeding reaction and using mother liquor to dissolve solid ammonium sulfate, the consumption of fresh water is reduced. The preparation of 1.0 tons of potassium sulfate product by the three-step method requires about 2.0 tons of production water (more than 80% of which is recycled secondary steam condensate), reducing fresh water usage by 176% compared to the two-step method. Since all fresh water ultimately enters the evaporation system, where it is separated through high-temperature evaporation by using steam. The reduction of water usage can reduce the steam consumption, thus achieving the purpose of energy saving and consumption reduction, so as to reduce the production cost.

In addition, in the method of the present disclosure, the raw materials of ammonium sulfate and potassium chloride are added into the reaction in two stages, so that the reaction concentration of each stage is reduced, which is beneficial to the full reaction of raw materials; at the same time, due to the reduction of solution concentration, the transportation of the solution is also convenient, so that the product quality is steadily improved step by step. The K₂O content of the primary crude potassium sulfate is 42.0%-43.5%, and the K₂O content of the secondary crude potassium sulfate is 45.0%-47.0%. In the third step, less water is required for washing. When the mass ratio of secondary crude potassium sulfate to water is 1:0.9-1.2, the K₂O content of the potassium sulfate product above 50.5% can be obtained. However, if the two-step method is adopted, when the washing water amount is 1.4-1.5 times of the crude product, the K₂O content of potassium sulfate product can barely reach above 50.0%, while the quality is not stable enough. To ensure that the K₂O content of potassium sulfate product exceeds 50.5%, the amount of washing water needs to be increased to more than 1.7 times. The three-step method not only consumes less water but also ensures stable and reliable product quality.
(3) Advantages of the third-stage reaction:

Since the K₂O content of the secondary crude potassium sulfate is 45.0-47.0%, the potassium sulfate product with K₂O content above 50.5% can be obtained by water washing in the third step, and the chloride ion content is below 0.3%, while the chloride ion content of most products prepared by experiments can reach below 0.1%. Therefore, in the third step, in order to further improve the K₂O content of potassium sulfate products, potassium chloride solution (the mass fraction of potassium chloride in the solution is between 1%-30%) can be further used to wash the potassium sulfate product after the reaction. Washing with potassium chloride solution can increase the K₂O content of potassium sulfate products, but at the same time, the chloride ion content of potassium sulfate products will also increase slightly. For example, if a potassium chloride solution with 10% potassium chloride mass fraction is used to wash the secondary crude potassium sulfate, the chloride ion content will increase to 0.3-0.5%, and the potassium sulfate content will also increase to 50.8-51.2% accordingly. Therefore, for products with a not too low requirement for chloride ion content, a potassium chloride solution with a relatively high mass fraction (the mass fraction between 1%-30%) can be used to wash the secondary crude potassium sulfate, so as to produce a potassium sulfate product with relatively high K₂O content and chloride ion content. Nevertheless, the chloride ion content still meets the requirements for Grade I crystalline potassium sulfate for agricultural use under the national standard GB/T 20406-2017, which requires the chloride ion content to be below 2.0%.
(4) Advantages of step-by-step dissolution of ammonium sulfate:

In the present disclosure, in the preparation of primary crude potassium sulfate, ammonium sulfate is dissolved by using the mother liquor of secondary crude potassium sulfate and fresh water. By introducing the mother liquor of secondary crude potassium sulfate, the recycling of the mother liquor of secondary crude potassium sulfate is realized, and at the same time, the consumption of fresh water is reduced. The mother liquor of primary crude potassium sulfate obtained after separation is sent to be evaporated and concentrated to prepare NK fertilizer. Due to the reduction of fresh water, the water to be evaporated is greatly reduced, so that the consumption of steam is reduced, thus realizing energy saving and consumption reduction.

In the present disclosure, in the preparation of the secondary crude potassium sulfate, the mother liquor of potassium sulfate product is used to dissolve the ammonium sulfate, eliminating the need to introduce fresh water for the dissolution of the ammonium sulfate, so that the recycling of the mother liquor of potassium sulfate product is realized, and the introduction of fresh water in the system is reduced. The separated mother liquor of secondary crude potassium sulfate is sent to the preparation section of the primary crude potassium sulfate. Due to the introduced fresh water needs to be evaporated and separated from the NK fertilizer evaporation system finally, the purpose of reducing steam consumption is achieved, thus realizing energy saving and consumption reduction.
(5) Advantages in environmental protection and energy consumption:

By reasonably adjusting the amount of mother liquor in each step, all mother liquors are circulated in the production system, so that the water balance and total solution balance between various processes of producing potassium sulfate are realized. Therefore, no production process solution or secondary steam condensate needs to be discharged externally.

In terms of energy consumption, in the present disclosure, the dynamic balance of solution quantity in each step of potassium sulfate production is realized without an additional evaporation device through twice feeding and the optimized solution (mother liquor) distribution, and the water evaporation per ton of potassium sulfate production is obviously reduced. According to the Chinese national standard GB29439-2012 “Standard Value of Energy Consumption per Unit Product of Potassium Sulfate”, the advanced value of energy consumption for producing potassium sulfate from resource-based potassium-containing brine in water-salt system method is 350 kgce/t, and the advanced value of energy consumption for the production process of potassium sulfate by the processing-type mirabilite method is 460 kgce/t. Based on the potassium sulfate product, the energy consumption of the present disclosure is 185 kgce/t, significantly lower than the advanced value of energy consumption for producing potassium sulfate by the water-salt system method.
(6) Innovation in industrialization

The reaction temperature of the method according to the present disclosure is 70° C.-95° C., which can be directly realized by steam heating, and the cooling crystallization temperature is 30° C.-50° C., which can be directly realized by cooling circulating water, so that the process is simple to implement and has low energy consumption.

According to the present disclosure, the raw material of potassium chloride is added into the reaction vessel in proportion in two steps, the efficiency of reactor is improved, the reaction extent of potassium chloride and ammonium sulfate is increased, and the reaction residence time of materials in the reaction vessel is shortened, so that the production efficiency can be improved, and the stability of product quality is also ensured.

The whole production process of the present disclosure is a liquid phase reaction system, all reactions and crystallization are conducted in the liquid phase, and all reaction solutions and crystal slurries can be transported by pump, making it convenient to transport and beneficial to industrial scale-up production. In the present process flow, novel forms of reactor and crystallizer are employed. Through modifications to existing reactors and crystallizers, the reaction efficiency is improved, the reaction duration is shortened, and the product exhibits excellent quality with appropriate grain size distribution.

The above are only preferred examples of the present disclosure and are not intended to limit the present disclosure, and for those skilled in the art, the present disclosure may have various modifications and changes. Any modifications, equivalent substitutions and improvements made within the spirit and principles of the present disclosure shall be included in the scope of protection of the present disclosure.

1. A method for producing a potassium sulfate by metathesis process, comprising:
taking a solid ammonium sulfate and a solid potassium chloride as raw materials, carrying out a first-stage reaction in a solution system, and then crystallizing and separating, so as to obtain a primary crude potassium sulfate;
taking the primary crude potassium sulfate, the solid ammonium sulfate and the solid potassium chloride as raw materials, carrying out a second-stage reaction in a solution system, and then crystallizing and separating, so as to obtain a secondary crude potassium sulfate, and
mixing the secondary crude potassium sulfate with a hot water at 80° C.-98° C., carrying out a third-stage reaction, and then crystallizing and separating.

2. The method according to claim 1, wherein a molar ratio of the solid ammonium sulfate to the solid potassium chloride for the first-stage reaction is 1:(1.4-2.2), and a molar ratio of the solid ammonium sulfate to the solid potassium chloride for the second-stage reaction is 1:(1.8-2.8).

3. The method according to claim 1, wherein a process of obtaining the primary crude potassium sulfate comprises: mixing and dissolving the solid ammonium sulfate, a mother liquor of secondary crude potassium sulfate and a water to obtain an ammonium sulfate solution, mixing the ammonium sulfate solution and the solid potassium chloride for conducting the first-stage reaction, and then cooling to crystallization and separating, so as to obtain the primary crude potassium sulfate and a mother liquor of primary crude potassium sulfate, wherein the mother liquor of secondary crude potassium sulfate is obtained by a process of separating and obtaining the secondary crude potassium sulfate.

4. The method according to claim 3, wherein a mass ratio of the solid ammonium sulfate, the mother liquor of secondary crude potassium sulfate and the water is 1:(2.0-3.2):(0.2-1.0);
preferably, a temperature of the first-stage reaction is controlled at 60° C.-90° C. and a reaction duration is controlled at 1 h-3 h;
preferably, a crystallization temperature after the first-stage reaction is controlled at 30° C.-60° C. and a crystallization duration is controlled at 1 h-3 h, and
preferably, when preparing the ammonium sulfate solution, a dissolution temperature is 60° C.-90° C.

5. The method according to claim 3, wherein the mother liquor of primary crude potassium sulfate is used to prepare an NK fertilizer byproduct;
preferably, the mother liquor of primary crude potassium sulfate is evaporated and concentrated to obtain a concentrated NK fertilizer mother liquor, the concentrated NK fertilizer mother liquor is crystallized and separated to obtain a wet NK fertilizer product and a NK fertilizer mother liquor, and the wet NK fertilizer product is dried to obtain a NK fertilizer product, and
more preferably, the NK fertilizer mother liquor is returned to an evaporation and concentration stage for recycling.

6. The method according to claim 3, wherein a process of obtaining the secondary crude potassium sulfate comprises: mixing and dissolving the solid ammonium sulfate, the primary crude potassium sulfate and a mother liquor of potassium sulfate product to obtain a crystal slurry mixed solution; mixing the crystal slurry mixed solution with the solid potassium chloride for a second-stage reaction, and then cooling to crystallization and separating, so as to obtain the secondary crude potassium sulfate and the mother liquor of secondary crude potassium sulfate, and using the mother liquor of secondary crude potassium sulfate to dissolve the solid ammonium sulfate in the first-stage reaction, wherein the mother liquor of potassium sulfate product is obtained by crystallization and separation after the third-stage reaction.

7. The method according to claim 6, wherein a mass ratio of the solid ammonium sulfate, the primary crude potassium sulfate and the mother liquor of potassium sulfate product is 1:(2.2-3.3):(4.8-6.2);
preferably, a temperature of the second-stage reaction is controlled at 60° C.-90° C. and a reaction duration is controlled at 1 h-3 h;
preferably, a crystallization temperature after the second-stage reaction is controlled at 30° C.-60° C. and a crystallization duration is controlled at 1 h-3 h, and
preferably, when preparing the crystal slurry mixed solution, a dissolution temperature is 60° C.-90° C.

8. The method according to claim 1, wherein a reaction temperature of the third-stage reaction is controlled at 60° C.-90° C. and a reaction duration is controlled at 0.5 h-2.0 h;
preferably, a mass ratio of the secondary crude potassium sulfate to the hot water is controlled at 1:(0.8-1.2);
preferably, the hot water and the potassium chloride are mixed first to obtain a potassium chloride solution with a mass fraction of 1%-30%, and then the potassium chloride solution is used to mix and react with the secondary crude potassium sulfate;
preferably, after the third-stage reaction, a crystallization is conducted at 30° C.-60° C. for 1 h-3 h, followed by a separation to obtain a wet potassium sulfate product and a mother liquor of potassium sulfate product, and the wet potassium sulfate product is dried to obtain a potassium sulfate product, and
more preferably, the mother liquor of potassium sulfate product is used to dissolve the solid ammonium sulfate in the second-stage reaction.

9. A potassium sulfate product, wherein the potassium sulfate product is prepared by the method according to claim 1, and
preferably, a K₂O content of the potassium sulfate product is 50.0 wt %-51.5 wt %, a chloride ion content is less than 0.3 wt %, a moisture content is less than 0.5 wt %, and a content of a water insoluble matter is less than 0.05 wt %.

10. A potash fertilizer, wherein the potash fertilizer comprises the potassium sulfate product according to claim 9.

11. The method according to claim 2, wherein a process of obtaining the primary crude potassium sulfate comprises: mixing and dissolving the solid ammonium sulfate, a mother liquor of secondary crude potassium sulfate and a water to obtain an ammonium sulfate solution, mixing the ammonium sulfate solution and the solid potassium chloride for conducting the first-stage reaction, and then cooling to crystallization and separating, so as to obtain the primary crude potassium sulfate and a mother liquor of primary crude potassium sulfate, wherein the mother liquor of secondary crude potassium sulfate is obtained by a process of separating and obtaining the secondary crude potassium sulfate.

12. The potassium sulfate product according to claim 9, wherein a molar ratio of the solid ammonium sulfate to the solid potassium chloride for the first-stage reaction is 1:(1.4-2.2), and a molar ratio of the solid ammonium sulfate to the solid potassium chloride for the second-stage reaction is 1:(1.8-2.8).

13. The potassium sulfate product according to claim 9, wherein a process of obtaining the primary crude potassium sulfate comprises: mixing and dissolving the solid ammonium sulfate, a mother liquor of secondary crude potassium sulfate and a water to obtain an ammonium sulfate solution, mixing the ammonium sulfate solution and the solid potassium chloride for conducting the first-stage reaction, and then cooling to crystallization and separating, so as to obtain the primary crude potassium sulfate and a mother liquor of primary crude potassium sulfate, wherein the mother liquor of secondary crude potassium sulfate is obtained by a process of separating and obtaining the secondary crude potassium sulfate.

14. The potassium sulfate product according to claim 13, wherein a mass ratio of the solid ammonium sulfate, the mother liquor of secondary crude potassium sulfate and the water is 1:(2.0-3.2):(0.2-1.0);
preferably, a temperature of the first-stage reaction is controlled at 60° C.-90° C. and a reaction duration is controlled at 1 h-3 h;
preferably, a crystallization temperature after the first-stage reaction is controlled at 30° C.-60° C. and a crystallization duration is controlled at 1 h-3 h, and
preferably, when preparing the ammonium sulfate solution, a dissolution temperature is 60° C.-90° C.

15. The potassium sulfate product according to claim 13, wherein the mother liquor of primary crude potassium sulfate is used to prepare an NK fertilizer byproduct;
preferably, the mother liquor of primary crude potassium sulfate is evaporated and concentrated to obtain a concentrated NK fertilizer mother liquor, the concentrated NK fertilizer mother liquor is crystallized and separated to obtain a wet NK fertilizer product and a NK fertilizer mother liquor, and the wet NK fertilizer product is dried to obtain a NK fertilizer product, and
more preferably, the NK fertilizer mother liquor is returned to an evaporation and concentration stage for recycling.

16. The potassium sulfate product according to claim 13, wherein a process of obtaining the secondary crude potassium sulfate comprises: mixing and dissolving the solid ammonium sulfate, the primary crude potassium sulfate and a mother liquor of potassium sulfate product to obtain a crystal slurry mixed solution; mixing the crystal slurry mixed solution with the solid potassium chloride for a second-stage reaction, and then cooling to crystallization and separating, so as to obtain the secondary crude potassium sulfate and the mother liquor of secondary crude potassium sulfate, and using the mother liquor of secondary crude potassium sulfate to dissolve the solid ammonium sulfate in the first-stage reaction, wherein the mother liquor of potassium sulfate product is obtained by crystallization and separation after the third-stage reaction.

17. The potassium sulfate product according to claim 16, wherein a mass ratio of the solid ammonium sulfate, the primary crude potassium sulfate and the mother liquor of potassium sulfate product is 1:(2.2-3.3):(4.8-6.2);
preferably, a temperature of the second-stage reaction is controlled at 60° C.-90° C. and a reaction duration is controlled at 1 h-3 h;
preferably, a crystallization temperature after the second-stage reaction is controlled at 30° C.-60° C. and a crystallization duration is controlled at 1 h-3 h, and
preferably, when preparing the crystal slurry mixed solution, a dissolution temperature is 60° C.-90° C.

18. The potassium sulfate product according to claim 9, wherein a reaction temperature of the third-stage reaction is controlled at 60° C.-90° C. and a reaction duration is controlled at 0.5 h-2.0 h;
preferably, a mass ratio of the secondary crude potassium sulfate to the hot water is controlled at 1:(0.8-1.2);
preferably, the hot water and the potassium chloride are mixed first to obtain a potassium chloride solution with a mass fraction of 1%-30%, and then the potassium chloride solution is used to mix and react with the secondary crude potassium sulfate;
preferably, after the third-stage reaction, a crystallization is conducted at 30° C.-60° C. for 1 h-3 h, followed by a separation to obtain a wet potassium sulfate product and a mother liquor of potassium sulfate product, and the wet potassium sulfate product is dried to obtain a potassium sulfate product, and
more preferably, the mother liquor of potassium sulfate product is used to dissolve the solid ammonium sulfate in the second-stage reaction.

19. A potash fertilizer, wherein the potash fertilizer comprises the potassium sulfate product formed according to the method of claim 8.
